(19) United States
(12) Patent Application Publication
(10) Pub. No.: US 2004/0035255 A1
(43) Pub. Date: Feb. 26, 2004

(54) Nailer's pliers

(76) Inventor: John D. Rion, Weir, KS (US)

Correspondence Address: BLACKWELL SANDERS PEPER MARTIN LLP, 720 OLIVE STREET, SUITE 2400, ST. LOUIS, MO, 63101, US

(21) Appl. No.: 10/226,913

(22) Filed: Aug. 23, 2002

(51) Int. Cl. B25C 3/00

(52) U.S. Cl. 81/44

(57) ABSTRACT

A set of nail holders is disclosed that include a holder that can hold relatively small, nails and that has a set of upwardly turned jaws and including one or more first alignment channels of particular dimensions. A further holder is disclosed that is operable to hold at least one second fastener having a width larger than the largest of the first alignment channel dimensions, the second holder having at least one second alignment channel. A large holder is also disclosed that is operable to hold a larger fastener having a width larger than the second alignment channel dimension. Additionally, the large holder has handles operable to substantially extend the reach of a user of the large holder.

### FIELD OF INVENTION

The present invention relates to tools for facilitating driving a nail through the surface of a structure. More specifically the invention relates to various types of pliers for conveniently holding a nail solidly in place while driving the fastener into a structure using, for example, a hammer.

### BACKGROUND OF INVENTION

Probably the most common way to start driving a fastener, such as a roofing nail into the surface of a structure, such as a piece of tin fastened to a roof, is by holding the nail between index finger and thumb and striking the nail with a steel hammer. Under the best of circumstances, the nail is started without injury to the person holding the nail. Nevertheless, this is not always the case, and many people who have attempted such a task have experienced the discomfort of smashing a finger or thumb with a misguided hammer. Accordingly, fastener holding devices have been used in the past, including clamps, vises, and pliers. Several such devices are designed to work with a wide range of fasteners, having approximately five to ten holes, causing the holding jaws to be so long as to prevent use in confined or hard-to reach places. Further, known jaws tend to be too thin, from the top to bottom, to hold large, long nails such as metal building nails, which need to be held very securely in order to get the nail securely started into the structure.

To partially compensate for the confined space problems associated with known fastener holders, U.S. Pat. No. 5,893,303 to Harris provides a holder with an offset handle. However, Harris still has the significant disadvantage of requiring the nose of the holder to lay flat on the surface into which the fastener is being driven. Further, Harris is too large and bulky for small tight places and not rugged enough for heavy hard nailing.

Other known fastener holders have similar deficiencies. For example, U.S. Pat. No. 3,919,903 to McAlister has pivotal handles that must lie perpendicular to a striking surface, causing the tool to be unusable in close quarters. Further, the device includes thin, movable fingers that are unsuited for firmly holding fasteners.

U.S. Pat. No. 4,079,765 to Hatayan (“the '765 patent”) provides a one-piece molded plastic implement that is intended to guide fasteners while being started into a surface. The implement disclosed in the '765 patent has a bridging portion that causes the jaws to apply pressure on a fastener when the handles are in a relaxed position. In order to release a fastener from the implement, for example, after the fastener is started, a user of the implement applies pressure to the handles. Accordingly, the implement disclosed in the '765 patent is not capable of firmly holding a fastener by allowing a user to increase the holding pressure exerted by the jaws. Further, the entire implement of the '765 patent must be held flat against a striking surface, rendering the implement unusable in confined spaces.

U.S. Pat. No. 4,201,258 to Elmore (“the '258 patent) discloses a holder very similar in configuration to the implement disclosed in the '765 patent, namely involving a pivoting mechanism that holds a nail only when the handle is in a relaxed position. Due to the design of the holder disclosed in the '258 patent, the entire holder must be positioned flat on a surface into which a nail is to be started, similarly rendering the holder unsuitable for use in confined spaces.

U.S. Pat. No. 4,843,923 to Voss (“the '923 patent”) is a fastener holding tool constructed out of plastic material such as an elastomer. While the tool has the ability to hold small fasteners in small spaces, the tool does not completely allow a user to keep his hands out of harms way. Further, the tool disclosed in the '923 patent is incapable of firmly holding larger fasteners, in, for example, roofing applications.

U.S. Pat. No. 5,293,792 to Chiang (“the '792 patent”) is a complicated nail clamping device that is similarly unsuited to firmly holding fasteners in, for example, confined or hard to reach spaces. The device has long jaws, including approximately 10 holes for clamping nails. Additionally, the holder must lay substantially flat on a surface, thus rendering it unsuitable to be used in hard to reach or confined spaces.

Accordingly, there is a need for nail holders that do not suffer from the shortcomings of known holders, that can be used in confined spaces, that adds to the reach of the user and that provides further advantages not found in known fastener holders.

### SUMMARY OF INVENTION

The present invention provides simple but sturdy tools for use in holding nails in place while being started with, for example, a hammer. Tools consistent with the present invention preferably have relatively shorter, upwardly curved jaws and longer handles for greater leverage. Such tools are easy to manufacture and convenient to carry.

A set of different sized nail holders is provided that includes a first holder operable to hold relatively small, pointed nails, the first holder having a set of upwardly-turned jaws and at least one first alignment channel having a first alignment channel dimension. The set also includes a second holder operable to hold at least one second fastener having a width larger than the first alignment channel dimension, the second holder having at least one second alignment channel having a second alignment channel dimension. A further member of the set is a third holder operable to hold at least one third fastener having a width larger than the second alignment channel dimension, wherein the third holder has a handle operable to substantially extend a reach of a user of the third holder.

Within the set of nail holders the first holder optionally has three first alignment channels. The second holder optionally has four-second alignment channels. And the third holder optionally has extended handles that are longer than approximately ten inches. In one embodiment, the third holder is operable to hold a twenty penny nail, and larger.

In alternative embodiments, a nail holder is provided that has upwardly turned jaws for holding a nail to facilitate driving the nail into a structure. The nail holder includes handles that are pivotally coupled with the upwardly turned jaws, the handles operable to cause the upwardly turned jaws to selectively securely hold and release the nail by griping or relaxing the hand of the user. The holder also includes at least one alignment channel formed in the upwardly turned jaws, the alignment channel operable to hold and align the nail based on the user griping the handles.

In an embodiment, the holder further includes at least one magnet for holding extra fasteners, coupled with at least one of the handles. The holder includes a spring positioned between the upwardly turned jaws to facilitate releasing the nail. In an embodiment, the spring is a small coil spring embedded into one of the jaws.

In an embodiment, the holder includes a strap connected between the handles that is optionally held in place through strap holes formed in the handles. Further, the holder optionally has plastic material applied to an underside of the upwardly turned jaws to prevent damage to the surface of the structure.

In an alternative embodiment, a method is provided for driving a nail partially into a structure using a nail holder. The method involves receiving the nail at an alignment channel associated with the nail holder, the nail holder having a set of upwardly bent jaws. The method further involves holding the nail proximate to a surface of the structure, the nail positioned substantially perpendicular to the surface, and striking the nail with a hammer so that the nail is partially driven into the structure.

### BRIEF DESCRIPTION OF DRAWINGS

These and other inventive features and advantages appear from the following Detailed Description when considered in connection with the accompanying drawings in which similar reference characters denote similar elements throughout the several views and wherein:

FIG. 1 illustrates a top view of a light duty embodiment in a closed position showing three exemplary alignment channels;

FIG. 2 illustrates a top view of the light duty embodiment in an open or relaxed position operable to receive a nail into an open alignment channel;

FIG. 3 illustrates a side view of the light duty embodiment, showing the jaws bent or tapered upwardly;

FIG. 4 illustrates a top view of general purpose embodiment in a closed position showing four alignment channels;

FIG. 5 shows the top view of the general purpose embodiment in an open or relaxed position to receive a nail, also showing the coil spring;

FIG. 6 shows the side view of the general purpose embodiment, showing the jaws bent or tapered up;

FIG. 7 shows a top view of a heavy duty embodiment in a closed position showing three relatively larger alignment channels;

FIG. 8 shows a top view of the heavy duty embodiment in an open or relaxed position to receive a nail, also showing the coil spring;

FIG. 9 shows a side view of the heavy duty embodiment, showing the jaws bent upwardly; and FIG. 10 shows a side view of a nail holder, the handles of which are oriented at an acute angle with respect to a striking surface when jaws associated with the holder are substantially parallel to the striking surface.

### DETAILED DESCRIPTION

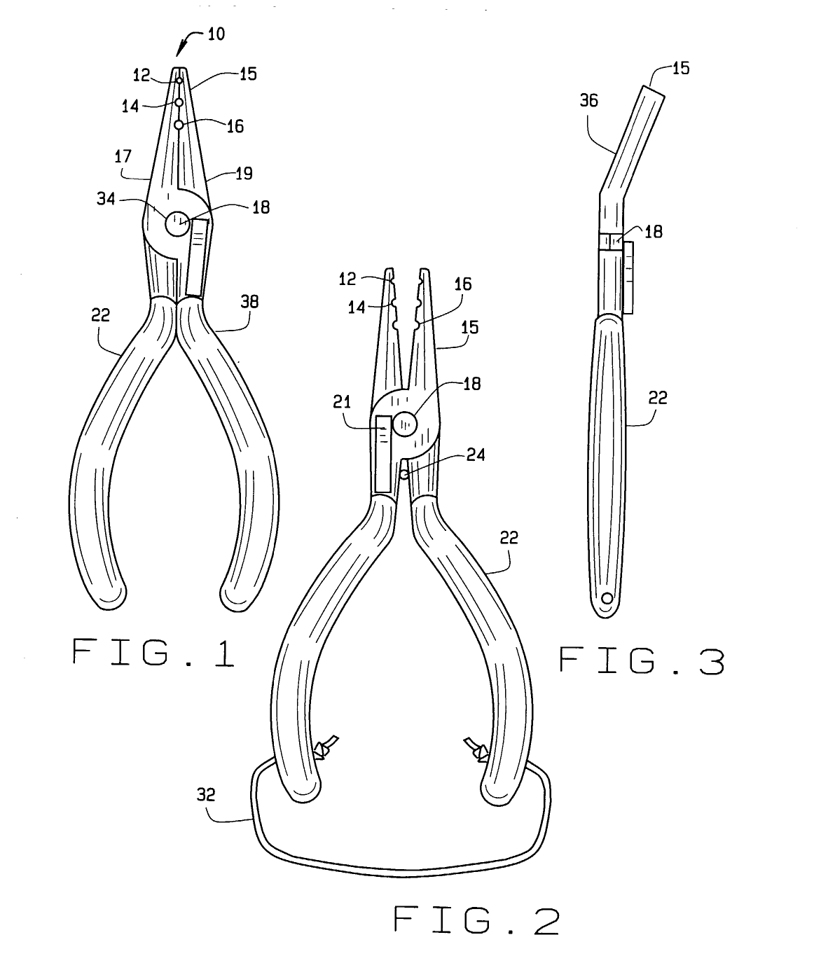

Referring generally to FIG. 1, which illustrates a top view of a light duty embodiment, holder 10 has jaws 15 and handles 22. The holder 10 is used to hold fasteners, such as nails, brads, nails, or screws in alignment channels 12, 14, and 16. An appropriate alignment channel is selected based on the diameter of the fastener to be held, so that the fastener can be held securely and at an appropriate angle relative to the surface of the structure into which the fastener is to be driven.

In one embodiment, the holder 10 is part of a set of different sized tools, each being well-suited for a slightly different purpose, i.e. the smallest holders are for holding small nails in tight places, such as around window sills, around cabinets, etc.; the next size is for general household use or around a workshop, where a user has additional room to work, for example nailing boards to a structure, building a dog house, and nailing tin on a building. Further, a substantially larger holder, which is relatively long, can be used for heavy-duty type purposes, and to reach up high or in extended-reach situations, under which a user could not otherwise reach to properly hold the fastener.

In one embodiment, the holder 10 is intended to be used such that the person driving the fastener squeezes the handles to hold the fastener securely for starting it into the desired structure, for example holding a nail tightly until it can be driven with a hammer sufficiently deeply into a structure so that the nail is started. In this embodiment, when the handles 22 are released an optional small coil spring 24, as best seen in FIG. 2, forces the jaws slightly apart for releasing of the started fastener and easy insertion of a subsequent fastener at which time the user's hand squeezes the handles and holds the new fastener securely.

Pivot point 18 provides a connection point between the two sections 17 and 19 of the holder 10. In one embodiment, a pivot is formed between the sections 17 and 19 so that the two sections are pivotally connected by way of a bolt or pin 34 at the pivot point 18. In one embodiment, a rubber grip 38 is provided on each of the handle sections of the tool 10 to conveniently and comfortably facilitate gripping the holder and to help prevent the tool from falling out of the user's hand.

FIG. 2 illustrates a top view of the light duty embodiment in an open or relaxed position operable to receive a fastener. The jaws 15 are shown in an open position so that the alignment channels 12, 14, and 16 form wider openings than when the holder is in the closed position as illustrated in connection with FIG. 1. Here, in FIG. 2, a fastener can be inserted into one of the alignment channels 12, 14, or 16 and the handles 22 squeezed by a user, causing the two jaws to pivot about the pivot point 18 thereby causing the tool to hold the fastener firmly in place. Next, the user places the pointed tip of the fastener on the surface of a structure and begins driving the fastener into the structure. After the fastener is started into the surface, the user can optionally release the fastener from the jaws 15 of the holder 10 and drive the fastener further into the desired structure without the interference from the holder 10. To facilitate release of the started fastener from the holder 10, an optional spring 24, such as a small coil spring is embedded into one side of the jaws 15, for example in a hole drilled in one of the jaws.

In one embodiment, a hole is formed in each of the handle sections, through which a strap 32 is connected for conveniently hanging the holder on a hook, or for supporting the holder on a user's wrist. An alternative strap is discussed in connection with FIG. 5. Returning to FIG. 2, optional magnet 21 is beneficial in that it allows the convenient, hands-free holding of fasteners that are ready to be driven into the desired structure.

FIG. 3 illustrates a side view of the light duty embodiment, showing the jaws bent or tapered upwardly. From the side view it can be most clearly seen how the jaws of the holder are advantageously bent upwardly to facilitate use of the holder in, for example, confined spaces and to allow the user to hold his or her hand away from the surface into which the user is driving the fastener. The handles 22 are used to apply pressure about the pivot point 18 to cause fasteners to be held in place in the jaws 15. The protective surface 36 is, for example, a rubber-like compound applied to the under surface of the jaws 15 of the holder 10 so that if the jaws 15 are placed on a smooth surface, such as a finished wooden cabinet, the holder 10 will not mar or scratch the surface, even if the holder is, for example, inadvertently hit by the hammer during the process of starting the fastener.

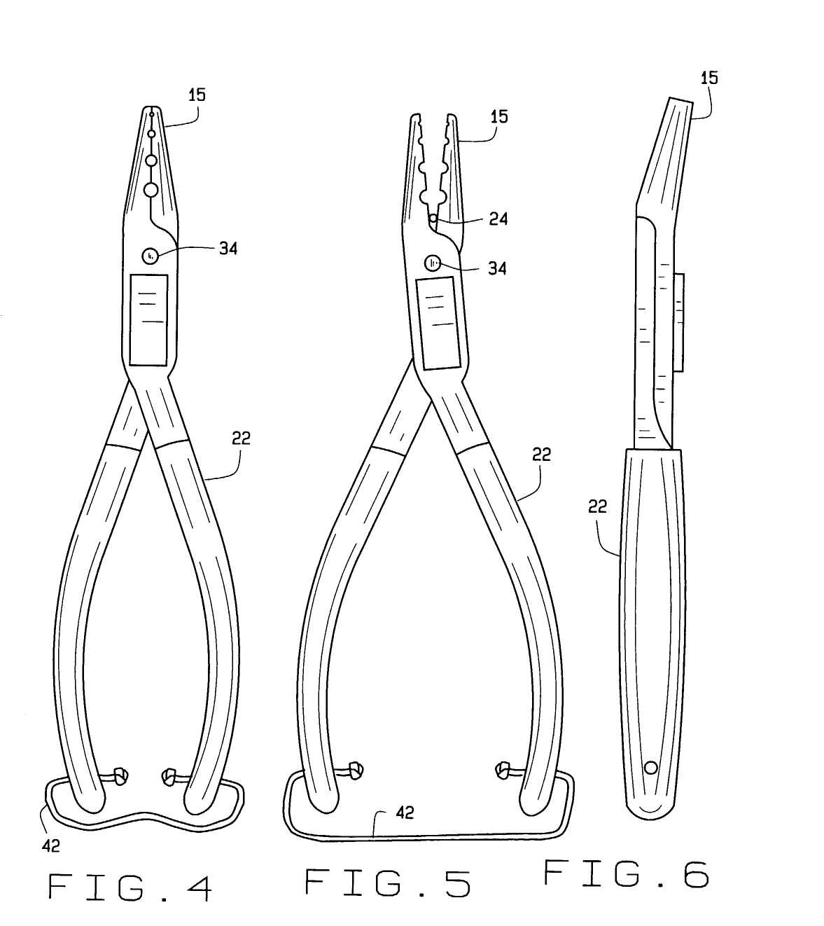

FIG. 4 illustrates a top view of general purpose embodiment in a closed position showing four alignment channels. In this general purpose embodiment, the handles 22 cause the jaws 15 to be closed tightly and to hold fasteners in the fastener alignment channels. The jaws 15 close tightly by pivoting about pin or bolt 34. In an embodiment, optional strap 42 is connected to the handles 22 through holes in the handles 22 and with stop knots being tied on the interior portions of the handles 22, so that the strap can be placed around the wrist of a user, for example.

FIG. 5 shows the top view of the general purpose embodiment in an open-relaxed position to receive a fastener. In this view the spring 24 is also visible. As described in connection with FIG. 2, the spring 24 causes the holder 10 to move in a position opposite to that of squeezing the handles 22. In this Figure, optional strap 44 is also illustrated. The strap 44 is connected near the end of each of the handles 22, for example through holes in the handles 22 with a stop knots in both ends of the strap 44 on the interior side of the handles 22.

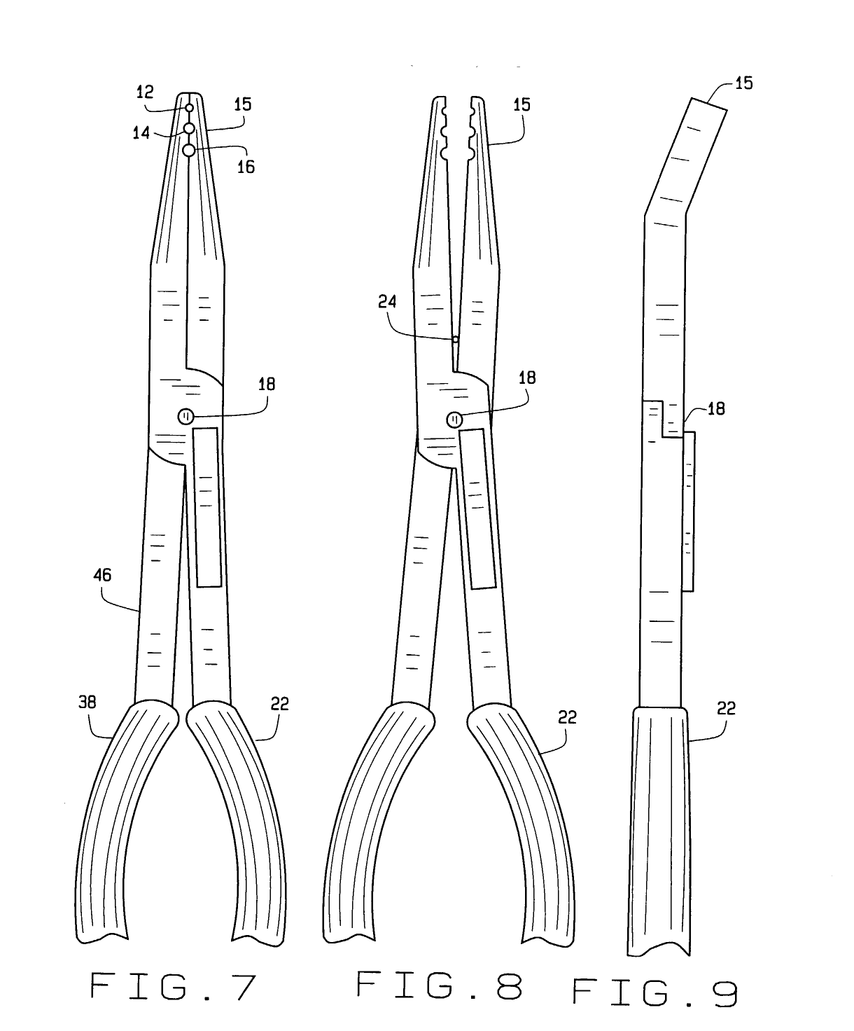

FIG. 6 shows a side view of the general purpose embodiment, showing the jaws bent formed upwardly. In this embodiment, the ends of the jaws 15 are tapered at the end for holding small, short fasteners, such as wire brads. Fasteners are held and released from the jaws 15 using the handles 22.

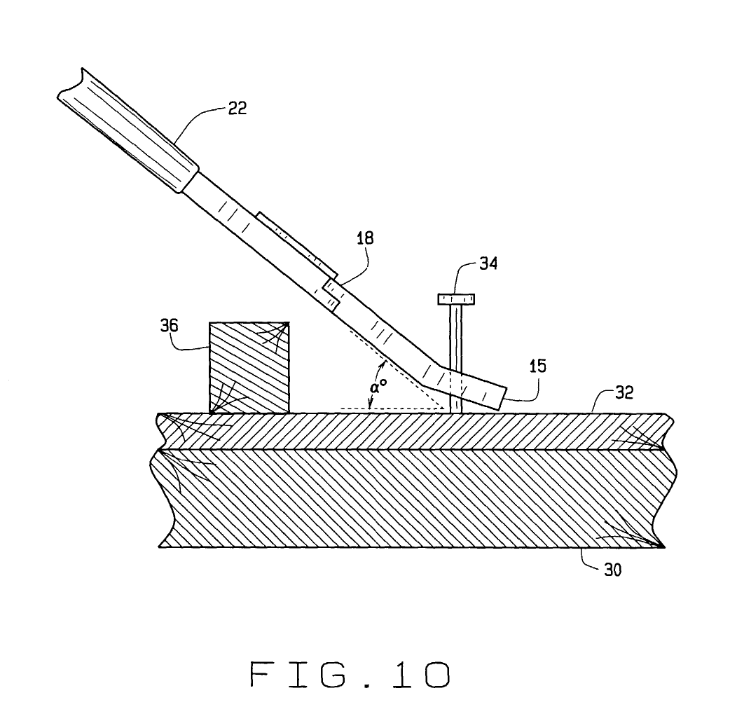

FIG. 7 shows a top view of the extended heavy-duty embodiment in a closed position showing three alignment channels including at least one larger-sized channel for use in connection with a large nail. Closed jaws 15 have alignment channels 12, 14, and 16 that are operable to tightly hold nails, when the jaws 15 are closed by pivoting the handles and jaws about the pivot point 18. Extended handle portion 46 is optionally not covered by the grip material 38. The extended handle portion 46 advantageously extends the reach of the user by positioning the alignment channels containing the fastener to be started further from the user's optionally extended hand. It is understood that the handles 22 shown in FIGS. 7-9, in connection with the extended, heavy-duty embodiment can also have a strap (not shown) in the handles 22, similar to straps 32, 42, and 44 of FIGS. 2, 4, and 5 respectively. As described above, the strap can advantageously be placed over a user's hand or wrist.

FIG. 8 shows a top view of the heavy-duty embodiment in an open or relaxed position to receive a fastener, also showing the spring 24. FIG. 9 shows a side view of the heavy-duty embodiment, also showing the jaws bent upwardly.

The exemplary holders of various disclosed sizes have the benefits of being able to work in highly varied situations. The small holder illustrated in connection with FIGS. 1-3 enables a user to easily apply fasteners in close corners, such as inside of cabinets, for example. The general purpose holder described in connection with FIGS. 4-6 is well suited to general purpose tasks. The large, heavy-duty holder described in connection with FIGS. 7-9 facilitate the holding of large nails, even 20 penny nails, for example or even larger. Further, the large holder adds approximately a foot to the users' reach, enabling him or her to hold the nail essentially as far as he or she can hammer.

In one embodiment, the holder 10 has relatively tall jaws to hold fasteners securely by virtue of the relatively longer alignment slots. In an embodiment, coil spring 24 is embedded into one of the jaws and is, therefore, out of the way and only opens the jaws slightly to allow a fastener to be inserted between the jaws. Because of the nature of the alignment slots, it is not necessary for the jaws to be opened particularly widely.

It is understood, that in alternative embodiments and without departing from the teachings of the present invention, the tool could be fabricated in such a way that releasing the handle causes, for example, a spring to cause the holder 10 to grasp a fastener in its jaws and squeezing the handle causes the jaws to release the fastener.

In particular embodiments, the jaws have less than five and preferably three or four alignment slots, and, therefore, can be used in more confined spaces than, for example relatively longer jaws having, for example, ten alignment rings. Further, in these embodiments, the tool is relatively easy to manufacture and convenient to use and carry in, for example, a pocket, pouch, or toolbox.

In the preferred embodiment, the jaws 15 of the holder 10 are optionally angled upwardly. It is understood that this can be accomplished during manufacturing, for example, by heating the jaws and bending them upwardly to provide the advantage of requiring only a small portion of the tool to lay on the surface of the structure into which the fastener is being driven.

In alternative embodiments, convenient features are added to the holder, such as a magnet on the holder near the hinge or the handle, to conveniently hold or carry nails. In an embodiment, holes are provided in both of the handles, to receive a strap therethrough. In this embodiment, the tool can be looped over the user's wrist so that, for example, when lining up a board or a sheet of tin, the holder can be hanging on the user's wrist.

Consistent with the present invention, the jaws 15 are tall enough to hold a substantial amount of the shaft of a fastener for a sturdy hold in highly-variable positions. Further, the jaws 15 are angled upwardly from being in line with the handles 22, which raises the handles, making for adequate room for users hand without interference with, for example a nailing surface. In one embodiment, the holder 10 is made analogously to standard pliers having flat, tall jaws. In this embodiment, the holder 10 is fabricated from a rugged metal, such as steel. Accordingly, in this embodiment, the holder 10 can withstand being inadvertently struck by a hammer. Further, a one-half alignment slot is formed in each jaw, for example by drilling a hole between the closed jaws. In an embodiment, a small coil spring is embedded in one jaw to lightly force apart the jaws when the user relaxes his or her hand so that a fastener can be easily inserted into the jaws.

FIG. 10 shows a side view of a nail holder, the handles 22 of which are oriented at an acute angle with respect to a striking surface 32 when jaws associated with the holder are substantially parallel to the striking surface. The handles 22 are upwardly turned at an acute angle α as indicated in FIG. 10. Any acute angle may be suitable, depending on the size and application of the nail holder. In the preferred embodiment of the light duty nail holder the angle may vary between about 20 to 40 degrees, although any acute angle will be suitable. In the preferred embodiment of the general purpose nail holder, the angle may optimally vary from about 20 to about 30 degrees, although any acute angle will be work. In the preferred embodiment of the heavy-duty nail holder, the angle may optimally vary from about 10 to about 20 degrees, although any acute angle will work. Special nail holders for overhead use could have an angle that optimally varies from about 70 too less than 90 degrees, although any acute angle will work. Consistent with the present invention, a user of the nail holder holds a fastener 34, such as a nail in the jaws 15 of the holder. The user applies pressure to the handles 22, which causes the jaws 15 to pivot about pivot point 18 and to hold the fastener 34 tightly. In this configuration, the user of the holder is able to hold the fastener 34 securely even in the presence and proximity of obstruction 36, which is for example a ledge or a window-sill. In this configuration the user of the holder can strike the fastener 34 until it is started into the striking surface 32. After the fastener 34 is started, the user can release the handles 22 and remove the holder from the immediate vicinity of the fastener 34. Then the user can continue to drive the fastener into the surface, for example fastening structure 30 to surface 32. The structure 30 can be for example a wooden board and the surface 32 a roofing shingle.

Holders consistent with the present invention have optional rubber cushioned handles 38 and optional rubber cushions 36 on the bottom side of the jaws to prevent marking the work area. It is understood that the optional spring 24, which opens the jaws, may be at the base of the jaws or on the other side of the pivot, depending on manufacturing details.

Holders 10 consistent with the present invention hold fasteners solidly, enabling the user to push down on a fastener and to strike the fastener hard with a hammer instead of just pecking at it as is done when holding a fastener with the fingers. Such an ability makes using the present invention faster and safer than using known methods and systems.

While exemplary embodiments and particular applications of this invention have been shown and described, it is apparent that many other modifications and applications of this invention are possible without departing from the inventive concepts herein disclosed. It is, therefore, to be understood that, within the scope of the appended claims, this invention may be practiced otherwise than as specifically described, and the invention is not to be restricted except in the spirit of the appended claims. Though some of the features of the invention may be claimed in dependency, each feature has merit if used independently.

1. A set of nail holders comprising:
a first holder operable to hold relatively small, nails, the first holder having a set of first jaws, a set of first upwardly-turned handles, and at least one first alignment channel having a first alignment channel dimension, the first alignment channel being oriented in a first alignment channel orientation with respect to a striking surface, the first jaws coupled with the first upwardly-turned handles such that the first upwardly-turned handles form an acute angle with the striking surface when the first alignment channel orientation is perpendicular with respect to the striking surface;
a second holder operable to hold at least one second fastener having a width larger than the first alignment channel dimension, the second holder having a set of second jaws, a set of second upwardly-turned handles, and at least one-second alignment channel having a second alignment channel dimension, the second alignment channel being oriented in a second alignment channel orientation with respect to the striking surface, the second jaws coupled with the second upwardly-turned handles such that the second upwardly-turned handles form an acute angle with the striking surface when the first alignment channel orientation is perpendicular with respect to the striking surface; and
a third holder operable to hold at least one third fastener having a width larger than the second alignment channel dimension, wherein the third holder has a set of third handles operable to substantially extend a reach of a user of the third holder.

2. The set of nail holders according to claim 1, wherein the first holder in the set of nail holders has three first alignment channels.

3. The set of nail holders according to claim 1, wherein the second holder in the set of nail holders has four-second alignment channels.

4. The set of nail holders according to claim 1, wherein the third handles associated with the third holder in the set of nail holders provides the user extended reach longer than approximately ten inches.

5. The set of a nail holders according to claim 1, wherein the third holder is operable to hold at least a size twenty penny nail.

6. A nail holder having jaws for holding a nail to facilitate driving the nail into a structure, the holder comprising:
handles that are pivotally coupled with the jaws, the handles operable to cause the jaws to selectively securely hold and release the nail based on the user griping or relaxing the handles, the handles being oriented with respect to the jaws such that the handles form an acute angle with a striking surface when the jaws are parallel to the striking surface;
at least one alignment channel formed in the jaws, the alignment channel operable to hold and align the nail based on the user squeezing the handles.

7. The nail holder as set forth in claim 6 further including at least one magnet for holding extra fasteners coupled with at least one of the handles.

8. The nail holder as set forth in claim 6 further including a spring positioned between the jaws to facilitate releasing the nail.

9. The nail holder as set forth in claim 8, wherein the spring is a small coil spring embedded into one of the jaws.

10. The nail holder as set forth in claim 6 further including a spring positioned between the base of the handles to facilitate releasing the nail.

11. The nail holder as set forth in claim 10, wherein the spring is a small coil spring embedded into one of the handles.

12. The nail -holder as set forth in claim 6 further including a strap connected between the handles.

13. The nail holder as set forth in claim 12, wherein the strap is held in place through strap holes formed in the handles.

14. The nail holder as set forth in claim 6 further including plastic material applied to an underside of the jaws to prevent damage to a surface of the structure.

15. A method of driving a nail partially into a structure using a nail holder, the method comprising:
receiving the nail at an alignment channel associated with the nail holder, the nail holder having a set of jaws and a set of handles, the handles being oriented with respect to the jaws such that the handles form an acute angle with a surface of the structure when the jaws are parallel to the surface;
holding the nail proximate to the surface, the nail positioned substantially perpendicular to the surface;
striking the nail with a hammer so that the fastener is partially driven into the structure.
